(19) United States
(12) Patent Application Publication
(10) Pub. No.: US 2010/0161887 A1
(43) Pub. Date: Jun. 24, 2010

(54) STORAGE DEVICE, CONTROL METHOD THEREOF, AND ELECTRONIC DEVICE USING STORAGE DEVICE

(75) Inventor: Shinichiro Nakazumi, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/641,254

(22) Filed: Dec. 17, 2009

(30) Foreign Application Priority Data
Dec. 19, 2008 (JP) 2008-323406

(51) Int. Cl. G06F 12/00; G06F 12/02

(52) U.S. Cl. 711/103; 711/202; 711/E12.001; 711/E12.008

(57) ABSTRACT

According to one embodiment, a storage device includes a physical address specifying module, a logical address group specifying module, a data writer, and a storage controller. The physical address specifying module specifies a physical address of write destination of data received together with a logical address among physical addresses each representing a block group including a block of each of flash memories connected in parallel the storage area of which is divided into a plurality of blocks for each sector. The logical address group specifying module specifies a logical address group including logical addresses based on the logical address. The data writer writes data of the logical addresses to blocks in the physical address. The storage controller stores the physical address where the data is written and the logical address group from which the data is written in an address conversion map in association with each other.

### CROSS-REFERENCE TO RELATED APPLICATIONS

This application is based upon and claims the benefit of priority from Japanese Patent Application No. 2008-323406, filed Dec. 19, 2008, the entire contents of which are incorporated herein by reference.

### BACKGROUND

1. Field

One embodiment of the invention relates to a storage device, a control method thereof, and an electronic device with the storage device.

2. Description of the Related Art

As storage devices that are used in personal computers, a magnetic disk device, such as a hard disk drive (HDD) has been commonly used. However, since the HDD comprises a driving component, such as a head or a motor, shock resistance is low, and erroneous operation or failure may occur due to a physical shock. Further, the HDD requires a seek time to move the head and a spin-up time to increase the revolutions of the disk, which causes time loss. Accordingly, in recent years, as a substitute for the HDD, a storage device called a solid state drive (SSD) that uses a flash memory as a nonvolatile memory has been developed.

The storage device using the flash memory is provided with an address conversion map to convert a logical address into a physical address to access a physical address of the flash memory corresponding to a logical address received from a host (see, for example, Japanese Patent Application Publication (KOKAI) No. 06-119128, Japanese Patent Application Publication (KOKAI) No. 2005-108304, and Japanese Patent Application Publication (KOKAI) No. 2001-67258). As a result, even if a storage position of data is changed in the flash memory, an access is made without notice from the host.

Generally, the address conversion map is used in the state where physical addresses are assigned to all logical addresses at the time of shipping from a factory or executing an initialization command. It is also often the case that, to shorten a format time, physical addresses are not assigned to all logical addresses at the time of shipping from a factory or executing an initialization command, and are assigned to the logical addresses when a write command is first issued.

In the storage device using the flash memory, since a transfer rate of the flash memory is lower than that of the HDD, a plurality of flash memories are connected in parallel to increase the transfer rate (see, for example, Japanese Patent Application Publication (KOKAI) No. 06-119128).

In recent years, with a rapid increase in the capacity of the storage device using the flash memory, the capacity of the address conversion map increases. For example, in the case of a storage device with a storage capacity of 512 GB, when a sector size is 512 Bytes, the total number of logical addresses is calculated by 512 GB/512 Bytes, and is 1×10⁹. In this case, in the address conversion map, when it is assumed that 4 Bytes are used for unit physical address, the capacity of the address conversion map may become 4 GB.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a storage device according to first and second comparative examples and an embodiment of the invention;

FIG. 2 is an exemplary view of an address conversion table stored in an address conversion map of the storage device in the first comparative example;

FIG. 3 is an exemplary view of an arrangement of logical addresses where physical addresses are assigned in the storage device in the first comparative example;

FIG. 4 is an exemplary view of an address conversion table stored in an address conversion map of the storage device in the second comparative example;

FIG. 5 is an exemplary view of a write operation of the storage device in the second comparative example;

FIG. 6 is an exemplary view of a read operation of the storage device in the second comparative example;

FIG. 7 is an exemplary functional block diagram of an MPU of the storage device in the embodiment;

FIG. 8 is an exemplary flowchart of a write operation of the storage device in the embodiment;

FIG. 9 is an exemplary view for explaining the write operation of the storage device in the embodiment;

FIG. 10 is an exemplary view of an address conversion table stored in an address conversion map of the storage device in the embodiment;

FIG. 11 is an exemplary flowchart of a read operation of the storage device in the embodiment; and

FIG. 12 is an exemplary block diagram of an electronic device provided with the storage device in the embodiment.

### DETAILED DESCRIPTION

Various embodiments according to the invention will be described hereinafter with reference to the accompanying drawings. In general, according to one embodiment of the invention, A storage device comprises a storage device includes a physical address specifying module, a logical address group specifying module, a data writer, and a storage controller. The physical address specifying module is configured to specify a physical address of a write destination of data received from a host together with a logical address among physical addresses each representing a block group including a block of each of a plurality of flash memories, which are connected in parallel and the storage area of which is divided into a plurality of blocks for each sector. The logical address group specifying module is configured to specify a logical address group including a plurality of logical addresses based on the logical address received from the host. The data writer is configured to write data of each of the logical addresses in the logical address group specified by the logical address group specifying module to each of blocks in the physical address specified by the physical address specifying module. The storage controller is configured to store the physical address where the data is written by the data writer and the logical address group from which the data is written in an address conversion map in association with each other.

According to another embodiment of the invention, an electronic device comprises a storage device. The storage device comprises a storage device includes a physical address specifying module, a logical address group specifying module, a data writer, and a storage controller. The physical address specifying module is configured to specify a physical address of a write destination of data received from a host together with a logical address among physical addresses each representing a block group including a block of each of a plurality of flash memories, which are connected in parallel and the storage area of which is divided into a plurality of blocks for each sector. The logical address group specifying module is configured to specify a logical address group including a plurality of logical addresses based on the logical address received from the host. The data writer is configured to write data of each of the logical addresses in the logical address group specified by the logical address group specifying module to each of blocks in the physical address specified by the physical address specifying module. The storage controller is configured to store the physical address where the data is written by the data writer and the logical address group from which the data is written in an address conversion map in association with each other.

According to still another embodiment of the invention, there is provided a storage device control method comprising: a physical address specifying module specifying a physical address of a write destination of data received from a host together with a logical address among physical addresses each representing a block group including a block of each of a plurality of flash memories, which are connected in parallel and the storage area of which is divided into a plurality of blocks for each sector; a logical address group specifying module specifying a logical address group including a plurality of logical addresses based on the logical address received from the host; a data writer writing data of each of the logical addresses in the logical address group specified by the logical address group specifying module to each of blocks in the physical address specified by the physical address specifying module; and a storage controller storing the physical address where the data is written by the data writer and the logical address group from which the data is written in an address conversion map in association with each other.

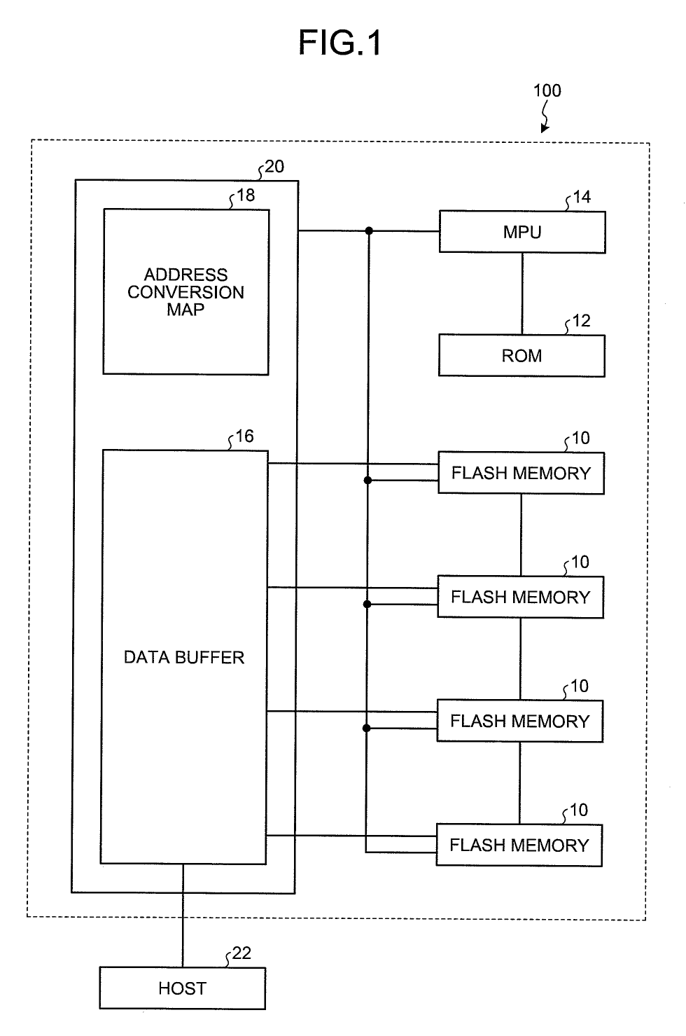

First, for the better understanding an embodiment of the invention, comparative examples will be described. FIG. 1 is a block diagram of a storage device 100 according to a first comparative example. The storage device 100 is, for example, a flash solid state drive (SSD).

As illustrated in FIG. 1, the storage device 100 comprises four flash memories 10, a read only memory (ROM) 12, a micro processing unit (MPU) 14, and a random access memory (RAM) 20 having a data buffer 16 and an address conversion map 18.

The flash memory 10 is used as a data storage element that stores data received from a host 22. A storage area of the flash memory 10 is divided into a plurality of blocks for every sector, and data can be read or written in units of the divided blocks. In the first comparative example and a second comparative example described below, a physical address is assigned to each block. The four flash memories 10 are connected in parallel with respect to the RAM 20. As a result, as described previously, a simultaneous read/write operation (parallel process) can be performed with respect to the four flash memories 10, and the transfer rate of the storage device 100 can be improved. For example, as illustrated in FIG. 1, when the four flash memories 10 are connected in parallel, if the transfer rate of each of the flash memories 10 is 20 MB/s, the storage device 100 can realize a transfer rate of 80 MB/s. The number of flash memories 10 that are connected in parallel is not limited to four. When the flash memories are connected in parallel, the transfer rate can be improved in a range of the maximum band of the RAM 20.

The ROM 12 stores in advance a control program that is executed by the MPU 14. The MPU 14 writes data to the flash memory 10 and reads data from the flash memory 10, and controls the overall operation of the storage device 100.

The data buffer 16 temporarily stores write data received from the host 22 or data read from the flash memory 10.

The address conversion map 18 stores an address conversion table where a logical address received from the host 22 and a physical address of the flash memory 10 are associated with each other. This enables an access to the physical address of the flash memory 10 corresponding to the logical address received from the host 22. Information of the address conversion table is transferred to at least one of the flash memories 10 and stored therein when the storage device 100 is turned off. When the storage device 100 is turned on, the information of the address conversion table stored in the flash memory 10 is transferred to the address conversion map 18.

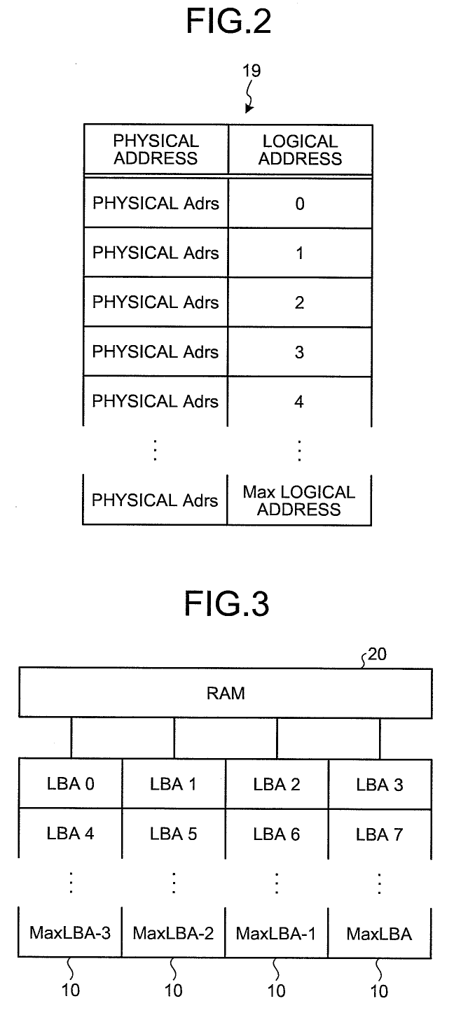

In this case, as illustrated in FIG. 2, an address conversion table 19 stored in the address conversion map 18 is used in the state where one physical address is assigned to each of the logical addresses in advance at the time of shipping from a factory or executing an initialization command. Generally, an access from the host 22 is not made in one sector unit, and is made with respect to a collection of a plurality of sectors. For this reason, as illustrated in FIG. 3, it is preferable that the logical addresses (hereinafter, “LBA”) be alternately arranged in the blocks of the four flash memories 10 in ascending order of address numbers of the logical addresses. In this case, for example, when an access is sequentially made from an LBA 0, the maximum band of the RAM 20 can be used.

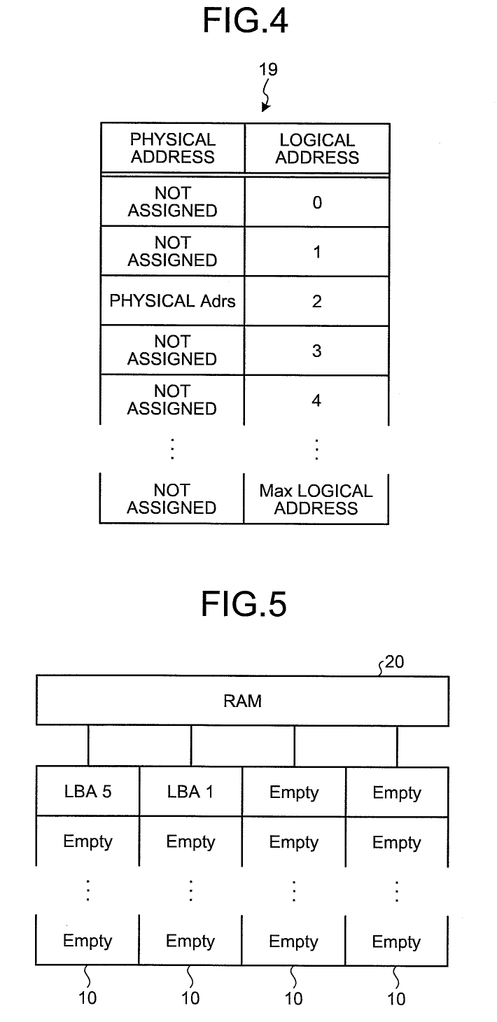

In the address conversion table 19, a physical address may not be assigned to all logical addresses at the time of shipping from a factory or executing an initialization command and may be assigned to a logical address received from the host 22 at the time of receiving a write command from the host 22 (second comparative example). For example, in FIG. 4, a physical address is assigned to an LBA 2 when a write command of the LBA 2 is received from the host 22. With this, since the same effect as in the case of formatting can be obtained by only clearing the address conversion table 19, as described previously, the format time can be shortened.

A data write operation and a data read operation in the second comparative example will be described in detail. FIG. 5 illustrates the case where the MPU 14 receives a write command of each sector from the host 22 in the order of an LBA 5 and an LBA 1.

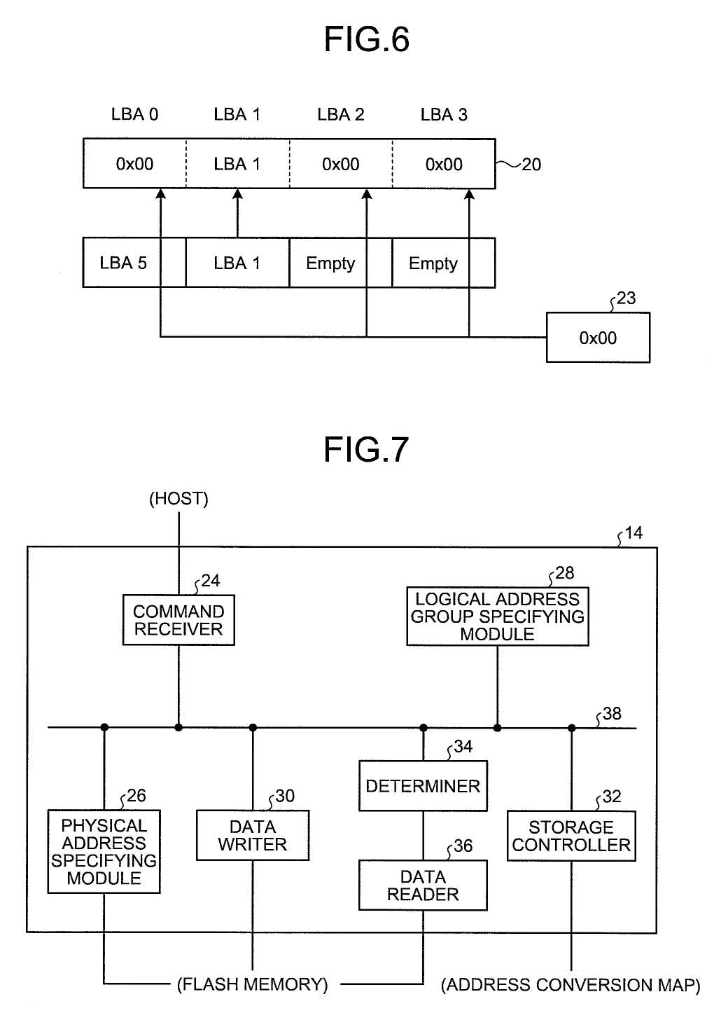

As illustrated in FIG. 5, when the MPU 14 receives data of each sector in the order of the LBA 5 and the LBA 1, generally, the LBA 5 and the LBA 1 are assigned sequentially from a head of the physical addresses and the data is written. Next, with reference to FIG. 6, the case where the MPU 14 receives a read command of the four sectors, the LBAs 0 to 3, from the host 22 when the data of the logical address is written as illustrated in FIG. 5 will be described.

As illustrated in FIG. 6, data of the LBAs 0, 2, and 3 are not written. Accordingly, with respect to the LBAs 0, 2, and 3, the MPU 14 reads initial data (0x00) from an initialization data dedicated area 23 provided in the flash memory 10, associates the initial data with the data read from the LBA 1, and temporarily stores them in the RAM 20. The MPU 14 transmits the data of the LBAs 0 to 3 to the host 22. The initialization data dedicated area 23 may be provided in each of the four flash memories 10 or may be provided in one of the four flash memories 10.

In the storage devices according to the first and second comparative examples, one physical address is assigned to each of all logical addresses. Consequently, when the capacity of the storage device 100 increases, the capacity of the address conversion map 18 also considerably increases.

In the following, the storage device 100 according to the embodiment will be described. The storage device 100 of the embodiment is, for example, a flash solid state drive (SSD). The storage device 100 of the embodiment is of basically the same configuration as that of the first comparative example illustrated in FIG. 1, and therefore, the description thereof will not be repeated.

As illustrated in FIG. 7, the MPU 14 in the storage device 100 of the embodiment comprises a command receiver 24, a physical address specifying module 26, a logical address group specifying module 28, a data writer 30, a storage controller 32, a determiner 34, and a data reader 36. The command receiver 24, the physical address specifying module 26, the logical address group specifying module 28, the data writer 30, the storage controller 32, the determiner 34, and the data reader 36 are connected to each other by a system bus 38. The command receiver 24, the physical address specifying module 26, the logical address group specifying module 28, the data writer 30, the storage controller 32, the determiner 34, and the data reader 36 are implemented when the MPU 14 reads a control program stored in the ROM 12 in advance and executes the control program.

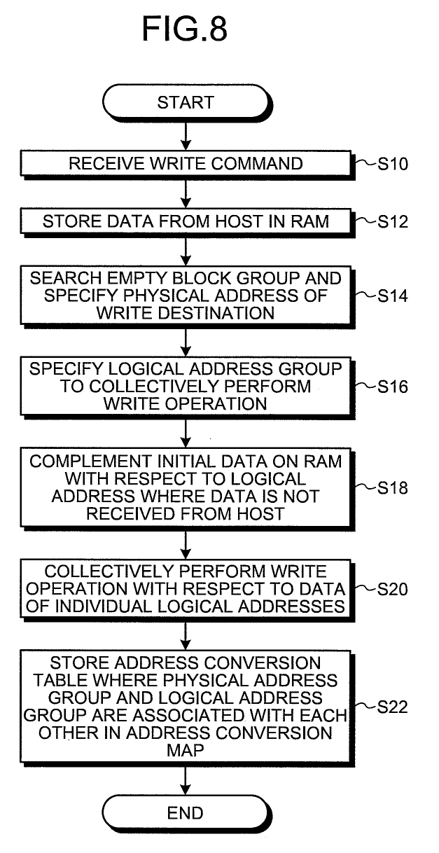

The command receiver 24 receives a write command and a read command from the host 22. When the write command is received by the command receiver 24, the physical address specifying module 26 specifies a physical address of a write destination of data of the logical address received from the host 22. The embodiment is different from the first and second comparative examples in that the physical address indicates a block group including one block of each of the four flash memories connected in parallel. That is, the four blocks are specified by one physical address. When the write command is received by the command receiver 24, the logical address group specifying module 28 specifies a logical address group based on the logical addresses received from the host 22. The logical address group includes logical addresses received from the host 22, and is formed of logical addresses corresponding to the number of the flash memories connected in parallel. That is, in the embodiment, the logical address group includes four logical addresses. The operation of the physical address specifying module 26 to specify a physical address and the operation of the logical address group specifying module 28 to specify a logical address group will be described in detail below with reference to FIG. 8.

The data writer 30 collectively writes data of logical addresses in a logical address group specified by the logical address group specifying module 28 to blocks in a physical address specified by the physical address specifying module 26, respectively. The storage controller 32 stores the address conversion table 19 where the physical address, which is specified by the physical address specifying module 26 and in which data is written to each block, is associated with the logical address group, which is specified by the logical address group specifying module 28 and includes logical addresses where data is written, in the address conversion map 18.

When the read command is received by the command receiver 24, the determiner 34 determines whether the logical address received from the host 22 is already assigned a physical address based on the address conversion map 18. When the determiner 34 determines that the logical address is assigned a physical address, the data reader 36 collectively reads data written to each of blocks in the corresponding physical address. When the determiner 34 determines that the logical address is not assigned a physical address, the data reader 36 reads initial data from the initialization data dedicated area 23 provided in the flash memory 10.

Next, a data write operation will be described with reference to FIG. 8. In the following, the case where the MPU 14 receives a write command of an LBA 5 from the host 22 will be described as a specific example.

Referring to FIG. 8, if the MPU 14 receives a write command of the LBA 5 from the host 22 (S10), the RAM 20 (data buffer 16) receives data of the LBA 5 from the host 22 and stores the data (S12).

The MPU 14 searches for an empty block group where data is not stored from the block groups including the blocks of the individual flash memories 10 connected in parallel, and specifies a physical address indicating an empty block group as a physical address of a write destination (S14). In other words, when the data is written, the MPU 14 does not refer to the address conversion table 19 stored in the address conversion map 18. That is, regardless of whether the physical address is already assigned to the logical address received from the host 22, the MPU 14 always searches for an empty block group, and specifies a physical address indicating an empty block group as a physical address of a write destination.

The MPU 14 specifies a logical address group from which data are collectively written to the block group of the physical address specified at S14 (S16). The logical address group is specified in a manner as described below. First, the MPU 14 calculates quotient 1 by dividing an address number 5 of the LBA 5 received from the host 22 by the number 4 of the flash memories 10 connected in parallel. The quotient 1 is multiplied by the number 4 of the flash memories 10 connected in parallel. An LBA 4 where an obtained value 4 is used as an address number is set as a head logical address of the logical address group. From the LBA 4 that is the head logical address, logical addresses of blocks corresponding to the number 4 of the flash memories 10 connected in parallel are specified as a logical address group. That is, the LBAs 4 to 7 are specified as a logical address group.

The MPU 14 complements the initial data (0x00) from the initialization data dedicated area 23 provided in the flash memory 10 on the RAM 20 with respect to the logical addresses (LBAs 4, 6, and 7) where data is not received from the host 22 among the logical addresses in the logical address group (LBAs 4 to 7) specified at S16 (S18).

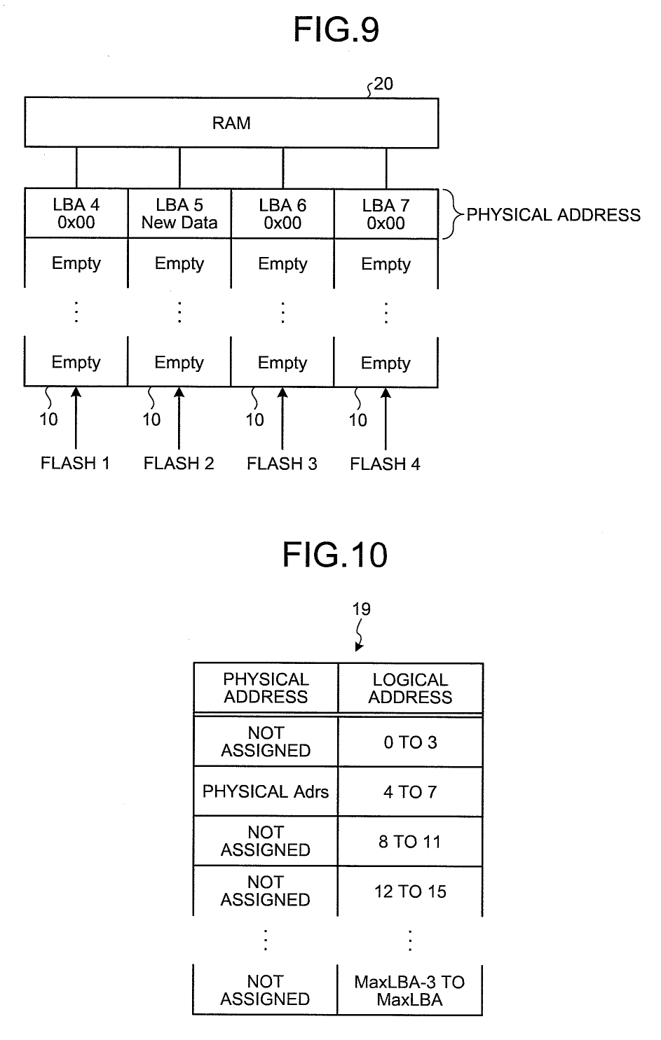

The MPU 14 collectively writes the data (data of the LBA 5) received from the host 22 and the initial data (data of the LBAs 4, 6, and 7) complemented from the initialization data dedicated area 23 stored in the RAM 20 to each of the blocks in the physical address specified at S14 (S20). Data of which logical address is written to which block among the blocks in the physical address is specified in a manner as described below. As illustrated in FIG. 9, numbers, flashes 1 to 4, are given to the four flash memories 10 connected in parallel, respectively. The address number 5 of the LBA 5 received from the host 22 is divided by the number 4 of flash memories 10 connected in parallel, and the remainder 1 is obtained. In this case, a correspondence relationship between the flashes 1 to 4 and the remainders 0 to 3 obtained by the calculation is determined in advance. For example, the flash 1 is determined to write data of the logical address of the remainder 0, the flash 2 is determined to write data of the logical address of the remainder 1, the flash 3 is determined to write data of the logical address of the remainder 2, and the flash 4 is determined to write data of the logical address of the remainder 3. Thus, as illustrated in FIG. 9, the data of the LBA 5 is specified to be written in the block of the flash 2. With this, the data of the LBAs 4 to 7 can be written in ascending order of address numbers.

Next, the MPU 14 creates a new address conversion table 19 in which a physical address where data is written and a logical address group (LBAs 4 to 7) where data is written are associated with each other, and stores the new address conversion table in the address conversion map 18 (S22). As illustrated in FIG. 10, one physical address is assigned to the LBAs 4 to 7. In this way, the data write operation for one sector is completed.

The MPU that performs the process of S10 corresponds to the command receiver 24 in FIG. 7. The MPU that performs the process of S14 corresponds to the physical address specifying module 26 in FIG. 7. The MPU that performs the process of S16 corresponds to the logical address group specifying module 28 in FIG. 7. The MPU that performs the process of S18 and S20 corresponds to the data writer 30 in FIG. 7. The MPU that performs the process of S22 corresponds to the storage controller 32 in FIG. 7.

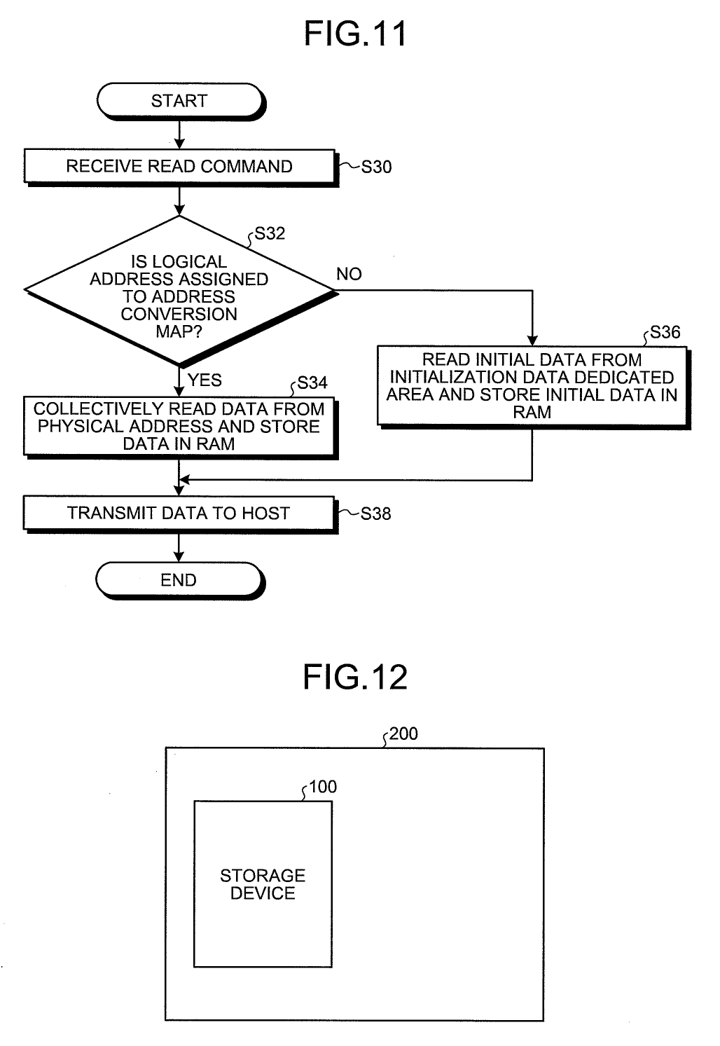

Next, data read operation will be described with reference to FIG. 11. In the following, as illustrated in FIGS. 9 and 10, the case where a physical address is assigned to logical addresses and data is written will be described as a specific example.

Referring to FIG. 11, if receiving a read command where a logical address is designated from the host 22 (S30), the MPU 14 determines whether the logical address received from the host 22 is already assigned to the address conversion map 18 (S32). For example, when a read command of four sectors, the LBAs 0 to 3, is received from the host 22, the MPU 14 determines that the logical address is not assigned to the address conversion map 18 (No at S32). When a read command of four sectors, the LBAs 4 to 7, is received from the host 22, the MPU 14 determines that the logical address is assigned to the address conversion map 18 (Yes at S32).

If the logical address is assigned (Yes at S32), the MPU 14 refers to the address conversion table 19 of the address conversion map 18, collectively reads data from the block group of the physical addresses indicated by the address conversion table 19, and transfers the data to the RAM 20 to store the data in the RAM 20 (S34). If the logical address is not assigned (No at S32), the MPU 14 reads the initial data from the initialization data dedicated area 23 of the flash memory 10, transfers the initial data to the RAM 20 to store the initial data in the RAM 20 (S36).

The MPU 14 transmits the data stored in the RAM 20 to the host 22 (S38). Thus, the data read operation is completed.

The MPU that performs the process of S30 corresponds to the command receiver 24 in FIG. 7. The MPU that performs the process of S32 corresponds to the determiner 34 in FIG. 7. The MPU that performs the process of S34 and S36 corresponds to the data reader 36 in FIG. 7.

As described above, according to the embodiment, when the four flash memories 10 are connected in parallel, as illustrated in FIG. 10, one physical address may be assigned to four logical addresses. That is, when N flash memories are connected in parallel, one physical address may be assigned to N logical addresses. As a result, as compared with the cases of the first and second comparative examples, the capacity of the address conversion map 18 can be reduced to 1/N.

As described above, when the storage device 100 is turned off, the information of the address conversion table 19 is transferred to the flash memory 10 and stored therein. That is, an area needs to be secured in the flash memory 10 in advance to store the information of the address conversion table 19. In the embodiment, since the amount of information of the address conversion table 19 decreases and the capacity of the address conversion map 18 decreases, the area that needs to be secured in the flash memory 10 can be smaller. In other words, according to the embodiment, in the storage area of the flash memory 10, the area where data exchanged with the host 22 are stored can be increased. The area where the information of the address conversion table 19 is stored may be provided in each of the four flash memories 10 or in one of the four flash memories 10.

After a write command is received from the host 22, the address conversion table 19 where a physical address is assigned to a logical address group is created. With this, the same effect as in formatting can be achieved by only clearing the address conversion table 19, and therefore format time can be shortened.

As illustrated in FIG. 9, each block in one physical address belongs to a storage area of each of the flash memories 10 connected in parallel. Accordingly, data can be collectively written to respective blocks in one physical address. A time required to write the data may be equal to a time required to write the data to one block.

As illustrated in FIG. 9, data is stored in each block in one physical address in the order of address numbers of logical addresses. Accordingly, when continuous data of the LBAs 4 to 7 are read, the maximum band of the RAM 20 can be used, and less time is required to read the data.

According to the embodiment, one physical address is assigned to four logical addresses. Accordingly, when continuous data are read, less time is required to check the physical address assigned to the logical addresses in the address conversion map 18. For example, when the continuous data of the LBAs 4 to 7 are read, in the first comparative example or the second comparative example, the physical address assigned to each of the LBAs 4 to 7 needs to be checked in the address conversion map 18. However, in the embodiment, since one physical address is assigned to the LBAs 4 to 7, less time is required to refer to the address conversion map 18.

When the physical address of the write destination of data from the host 22 is specified, regardless of whether the physical address is already assigned to the logical address received from the host 22, an empty block group is always searched for, and a physical address indicating an empty block group is specified as the physical address of the write destination. Thus, with respect to all the blocks obtained by dividing the storage area of the flash memory 10, data is written the same number of times.

The storage device 100 of the embodiment is suitably provided to an electronic device 200 as illustrated in FIG. 12. Examples of the electronic device 200 include a telephone, an audio machine, a personal computer, and a data storage device such as an HDD recorder. As described previously, since the storage device using the flash memory has excellent shock resistance, the storage device 100 of the embodiment is suitably provided to a portable electronic device, such as a mobile telephone, a mobile audio machine, or a notebook computer.

While, in the embodiment, the four flash memories 10 connected in parallel are described by way of example, it is not so limited. The number of flash memories may be arbitrary. By connecting the flash memories 10 in parallel, the data transfer rate can be improved in a range of the maximum band of the RAM 20.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a physical address selector configured to select a physical address of a write destination of data received from a host together with a logical address among physical addresses indicative of block groups comprising blocks of flash memories connected in parallel comprising storage areas divided into blocks for sectors;
a logical address group selector configured to select a logical address group comprising a plurality of logical addresses based on the received logical address;
a data writer configured to write data of the logical addresses in the selected logical address group to blocks in the selected physical address; and
a storage controller configured to store the selected physical address and the selected logical address group in an address mapping table.

2. The storage device of claim 1, wherein the logical address group selector is configured to divide an address number of the received logical address by number of the flash memories connected in parallel in order to calculate a quotient, to select a value multiple of the quotient by the number of the flash memories as an address number of a head of the logical address, and to select logical addresses corresponding to the number of the flash memories from the address number of the head of the logical address as the logical address group.

3. The storage device of claim 1, wherein the data writer is configured to initial data of a logical address not received from the host, and to collectively write the data of the logical addresses in the logical address group.

4. The storage device of claim 1, wherein the data writer is configured to divide an address number of a logical address in the selected logical address group by number of the flash memories connected in parallel in order to calculate a remainder, and to store data of the logical address in a block of one of the flash memories determined based on the remainder.

5. The storage device of claim 1, wherein the physical address selector is configured to select a physical address representing a block group without data.

6. The storage device of claim 1, further comprising:
a determiner configured to determine whether the address mapping table stores the physical address associated with the received logical address, when a data read command is received from the host; and
a data reader configured to collectively read data in a block group represented by the physical address when the determiner determines that the physical address is stored, and to read initial data from the flash memories when the determiner determines that the physical address is not stored.

7. An electronic device comprising a storage device comprising:
a physical address selector configured to select a physical address of a write destination of data received from a host together with a logical address among physical addresses indicative of block groups comprising blocks of flash memories connected in parallel comprising storage areas divided into blocks for sectors;
a logical address group selector configured to select a logical address group comprising a plurality of logical addresses based on the received logical address;
a data writer configured to write data of the logical addresses in the selected logical address group to blocks in the selected physical address; and
a storage controller configured to store the selected physical address and the selected logical address group in an address mapping table.

8. A storage device control method comprising:
selecting a physical address of a write destination of data received from a host together with a logical address among physical addresses indicative of block group comprising blocks of flash memories connected in parallel comprising storage areas divided into blocks for sectors;
selecting a logical address group comprising a plurality of logical addresses based on the received logical address;
writing data of the logical addresses in the selected logical address group to blocks in the selected physical address; and
storing the selected physical address and the selected logical address group in an address mapping table.
